(19) United States
(12) Patent Application Publication
(10) Pub. No.: US 2006/0262710 A1
(43) Pub. Date: Nov. 23, 2006

(54) Recording medium, and method and apparatus for reproducing data from the recording medium

(76) Inventors: Young Sun Shim, Seoul (KR); Byung Jin Kim, Seongnam-si (KR); Sung Wan Park, Suwon-si (KR)

Correspondence Address: HARNESS, DICKEY & PIERCE, P.L.C., P.O. BOX 8910, RESTON, VA, 20195, US

(21) Appl. No.: 11/416,178

(22) Filed: May 3, 2006

Related U.S. Application Data
(60) Provisional application No. 60/682,822, filed on May 20, 2005.

(30) Foreign Application Priority Data
Feb. 9, 2006 (KR) 10-2006-0012640

(51) Int. Cl. G11B 7/24

(52) U.S. Cl. 369/275.1

(57) ABSTRACT

A recording medium for protecting content data, and a method and apparatus for reproducing data are disclosed. A method for reproducing data includes the steps of: a) confirming information constraining output resolution of the data according to a region; b) comparing the information with region value indicating a region in which a player is to be played; and c) outputting the data according to the result of the comparison. Therefore, the apparatus limits data output resolution until a current time reaches an analog output sunset time, thereby protecting the content data. The apparatus can prevent content data from being illegally duplicated or distributed by a fraudulent user, and can assign different content protection degrees to individual regions, resulting in the creation of more convenient functions for a content provider (CP) and a legitimate user.

This application claims the benefit of the Korean Patent Application No. 10-2006-0012640, filed on Feb. 9, 2006, which is hereby incorporated by reference as if fully set forth herein.

This application claims the benefit of the U.S. Provisional Application No. 60/682,822, filed on May 20, 2005, in the name of inventors Young Sun SHIM, Sung Wan PARK and Byung-Jin KIM, entitled “METHOD FOR SETTING THE ICT(IMAGE CONSTRAINT TOKEN) INFORMATION”, which is hereby incorporated by reference as if fully set forth herein.

### BACKGROUND OF THE INVENTION

1. Field of the Invention

The present invention relates to a method and apparatus for reproducing data from a recording medium or a local storage, and more particularly to an optical recording medium including data protection information, and a method and apparatus for reproducing data from the optical recording medium using the data protection information.

2. Discussion of the Related Art

Generally, there has been widely used an optical disc acting as a recording medium capable of recording a large amount of data therein. Particularly, there has recently been developed a high-density optical recording medium capable of recording/storing high-quality video data and high-quality audio data for a long period of time, for example, a Blu-ray Disc (BD) and a High-Definition Digital Versatile Disc (HD-DVD), etc.

The BD based on the next-generation recording medium technique has been considered to be the next-generation optical recording solution capable of storing much more data than a conventional DVD. In recent times, many developers have conducted intensive research into the international standard technical specification associated with the BD along with those of other digital devices.

In association with a method for reproducing an external input signal and data of a high-density recording medium, a method for protecting content data received from a content provider (CP) has not yet been established, such that many limitations and problems occur in developing an optical recording/reproducing device based on the high-density recording medium.

In association with the above-mentioned description, there has recently been developed an optical recording/reproducing device based on the high-density recording medium standard, but the high-density recording medium standard has not yet been completed, such that many limitations and problems occur in developing the optical recording/reproducing device.

### SUMMARY OF THE INVENTION

Accordingly, the present invention is directed to a recording medium, and a method and apparatus for reproducing data from the recording medium and/or local storage that substantially obviate one or more problems due to limitations and disadvantages of the related art.

An object of the present invention is to provide a method and apparatus for protecting content data received from an authorized content provider (CP).

Another object of the present invention is to provide a recording medium including content protection information, and a method and apparatus for reproducing the content protection information.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a recording medium comprises: a first-type area for storing content data; and a second-type area for storing information constraining output resolution of the data according to a region.

Besides, the second-type area can be a database area.

Besides, the second-type area can be a header area of a stream.

Besides, the information can be Image Constraint Token (ICT).

Besides, the information can indicate whether to constrain output resolution of the data in each of regions.

Besides, the information can specify a region in which output resolution of the data is constrained.

Besides, the information can be stored according to each title.

Besides, the second-type region can include: a first area for storing information of a region in which the data is to be reproduced; and a second area for information indicating whether to constrain output resolution of the data.

Besides, the region can be indicated by region code. Besides, the region can be indicated by a country code. Besides, the region can be indicated by a language code.

In another aspect of the present invention, there is provided a method for reproducing comprising the steps of: a) confirming information constraining output resolution of data according to a region; b) comparing the information with region value indicating a region in which a player is to be played; and c) outputting the data according to the result of the comparison.

Besides, the data is output in the form of constrained image in case that the result indicates that the output resolution is constrained in the corresponding region.

Besides, the data is output in the form of original image in case that the result indicates that the output resolution is not constrained in the corresponding region.

Besides, the region value can be stored in a “Player Status Register”.

Besides, the information can indicate whether to constrain output resolution of the data in each of regions.

Besides, the information can specify a region in which the out resolution constraint of the data is constrained.

Besides, the information can be confirmed by referring to both a first area for storing information of a region in which the data is to be reproduced and a second area for storing indicating whether output resolution of the data is constrained.

In yet another aspect of the present invention, there can be provided an apparatus for reproducing data comprising: a playback system storing region value of the apparatus; and a controller confirming information constraining output resolution of the data, the controller comparing the information with the region value indicating a region in which the apparatus is to be played, the controller controlling the playback system to output the data according to the result of the comparison.

Besides, the controller outputs the data in the form of constrained image in case that the result in case that the result indicates that the output resolution is constrained in the corresponding region.

Besides, the controller outputs the data in the form of original image in case that the result in case that the result indicates that the output resolution is not constrained in the corresponding region.

Besides, the region value is stored in a “Player Status Register” of the playback system.

Therefore, the present invention allows the content provider (CP) to provide the user with content data safely, thereby protecting the content provider (CP) and an authorized user of the content data.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a conceptual diagram illustrating a method and apparatus for reproducing data from a recording medium according to the present invention;

FIG. 2 is a conceptual diagram illustrating a file structure recorded in an optical disc acting as a recording medium according to the present invention;

FIG. 3 is a structural diagram illustrating a data record structure of an optical disc acting as a recording medium according to the present invention;

FIG. 4 is a block diagram illustrating an optical recording/reproducing device according to the present invention;

FIG. 5 is a block diagram illustrating an apparatus for reproducing data using playback system according to the present invention;

FIG. 6 is a conceptual diagram illustrating information constraining output resolution of data according to a first preferred embodiment of the present invention;

FIG. 7 is a conceptual diagram illustrating information constraining output resolution of data according to a second preferred embodiment of the present invention;

FIG. 8 is a conceptual diagram illustrating information constraining output resolution of data according to a third preferred embodiment of the present invention;

FIGS. 9A˜9B show exemplary record locations in which information constraining output resolution of data is recorded according to the present invention; and

FIG. 10 is a flow chart illustrating a method for reproducing data according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

A method and apparatus for reproducing data from a recording medium will hereinafter be described with reference to the annexed drawings.

For the convenience of description and better understanding of the present invention, the optical disc, such as a BD, will hereinafter be exemplarily used as the above-mentioned recording medium in the present invention. It should be noted that technical ideas of the present invention can be applied to other recording mediums without departing from the scope and spirit of the invention.

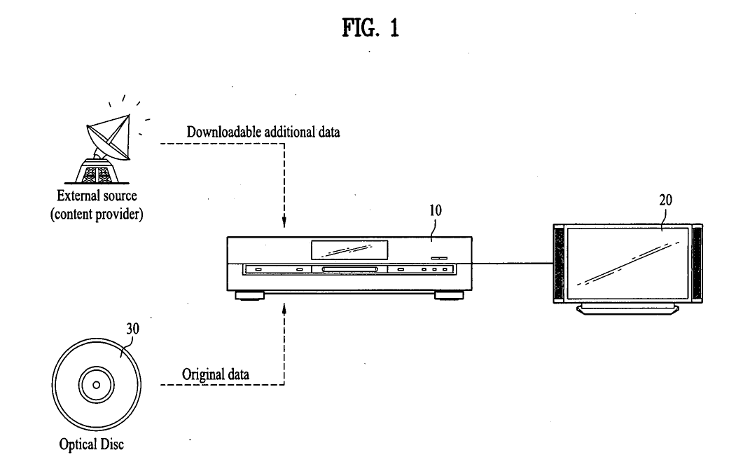

The term “local storage” is indicative of a storage unit contained in an optical recording/reproducing device 10 shown in FIG. 1. In more detail, the term “local storage” is indicative of a component capable of receiving necessary information or data from a user, and storing the received information or data. For example, a general local storage may be indicative of a Hard Disc Drive (HDD), a system memory, or a flash memory, but it should be noted that the term “local storage” of the present invention is not limited to the HDD, the system memory, or the flash memory, and is applicable to other examples as necessary.

Particularly, the term “local storage” is indicative of a storage unit for storing data associated with a recording medium. The data associated with the recording medium is generally downloaded from an external device.

In association with the above-mentioned description, it is obvious to those skilled in the art that the local storage may directly read some permission data from the recording medium, and may generate system data (e.g., metadata) associated with record/reproduction operations of the recording medium, such that the system data may be stored in the local storage.

For the convenience of description, data recorded in the recording medium is referred to as “original data”, data associated with the recording medium from among a plurality of data units stored in the local storage is referred to as “additional data”.

The term “Title” is indicative of a reproduction unit interfacing with a user, and each title is linked to a specific object, such that a stream associated with a corresponding title recorded in a disc is reproduced according to a command or program stored in the object. Particularly, for the convenience of description and better understanding of the present invention, a first title in which movies and interactive information according to an MPEG2 compression scheme are recorded is called an HDMV title, and a second title in which movies and interactive information according to a Java program are recorded is called a BD-J title.

FIG. 1 is a conceptual diagram illustrating a method and apparatus for reproducing data according to the present invention. Unified usages of the optical recording/reproducing 10 and peripheral devices are shown in FIG. 1.

The optical recording/reproducing device 10 can record/reproduce data in/from various optical discs having different formats. If necessary, the optical recording/reproducing device 10 can record/reproduce specific data in/from only a specific optical disc such as a BD, or can reproduce the data from the optical disc without recording the data in the same. It should be noted that the present invention exemplarily uses a BD-player capable of reproducing data from the BD or a BD-recorder capable of recording data in the BD in consideration of correlation between the BD and peripheral devices for the convenience of description. In association with the above-mentioned description, it is well known in the art that the optical recording/reproduction device 10 is also applicable to a drive embedded in a specific device such as a computer.

The optical recording/reproducing device 10 records or reproduces data in the optical disc 30, receives an external input signal, performs a signal process on the received signal, and transmits the signal processed result to the external display 20, such that a user can view the signal processed result on the display 20. In this case, there is no limitation in a receivable external signal. For example, representative external input signals may be determined to be DMB(Digital Multimedia Broadcasting)-associated signal and an Internet-associated signal, etc. Specifically, the Internet is indicative of a communication network to which a user easily gains access, such that the user can download specific Internet data using the optical recording/reproducing device 10, and can use the downloaded data.

In association with the above-mentioned description, an entity for providing content data used as an external source is generally referred to as a content provider (CP).

The term “Content” is indicative of content data of the title, and is equal to data received from an author of a recording medium.

Particularly, the present invention aims to prevent the content data from being illegally duplicated or distributed. In addition, although the content data is illegally duplicated and distributed, the present invention aims to minimize damage of the content provider.

Original data and additional data will hereinafter be described in detail.

For example, it is assumed that multiplexed AV (Audio/Video) streams are recorded as the original data recorded in the optical disc, and additional data for use in the Internet is an audio stream different from an audio stream (e.g., Korean) of the original data. In this case, some users may download audio stream (e.g., English) acting as additional data from the Internet, may desire to reproduce the downloaded audio stream along with the AV stream acting as original data, or may desire to reproduce only the additional data. In order to implement the above-mentioned desires of the users, correlation between the original data and the additional data shall be established, and there is needed a systemized method for managing/reproducing the above-mentioned data according to a user request.

For the convenience of description, although a signal recorded in the disc is referred to as the original data, and other signals existing in the outside of the disc are referred to as the additional data, it should be noted that the original data and the additional data classified according to their data acquisition methods are not limited to only specific data. Generally, data associated with the original data, and existing in the outside of the optical disc may act as additional data.

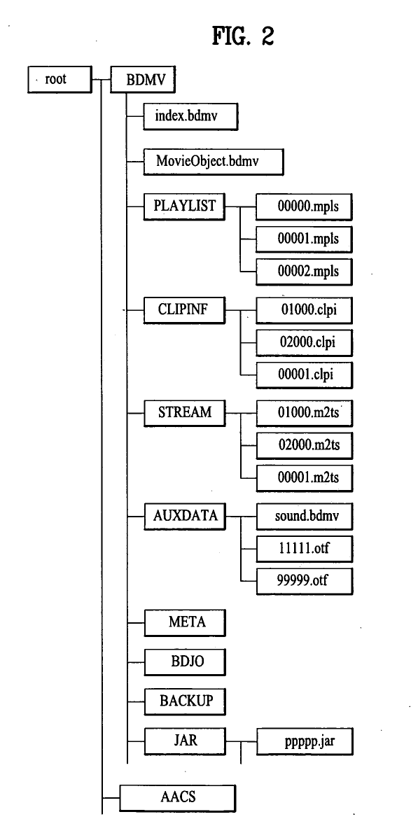

In order to satisfy the above-mentioned user requests, a predetermined file structure must be established between the original data and the additional data. Accordingly, a file structure and data record structure for use in the BD will hereinafter be described with reference to FIGS. 2˜3.

FIG. 2 is a conceptual diagram illustrating a file structure for reproducing/managing the original data recorded in an optical disc according to the present invention.

Referring to FIG. 2, the file structure according to the present invention includes an AACS directory and one or more BDMV directories under a single root directory. The BD directory (BDMV) includes not only an index file “index” acting as a general file (i.e., an upper file) capable of guaranteeing user interactivity, but also the above-mentioned object. The file structure includes a variety of directories storing information of actual data recorded in a disc and other information associated with a method for reproducing the data, for example, a PLAYLIST directory, a CLIPINF directory, a STREAM directory, an AUXDATA directory, a BDJO directory, a META directory, and a BACKUP directory. The above-mentioned directories and a variety of files included in the directory will hereinafter be described.

The META directory includes a metadata file acting as “Data about Data”. In other words, the META directory includes a search file and a metadata file for Disc Library.

The BDJO directory includes a BD-J object file for reproducing a BD-J title.

The AUXDATA directory includes an additional data file for reproducing data of the disc. For example, the AUXDATA directory includes a “Sound.bdmv” file for providing a user with sound data when an interactive graphic function is executed, and an “11111.otf” file for providing the user with font information when data of the disc is reproduced.

The STREAM directory includes a plurality of AV stream files recorded in a disc according to a specific format. Generally, individual streams are recorded using an MPEG based transport packet, and the STREAM directory uses extension names of stream files (01000.m2ts and 02000.m2ts) as a specific extension name “*.m2ts”. Particularly, if video/audio/graphic data is multiplexed in a stream, the stream is called an AV stream, and a single title is composed of at least one AV stream file.

The CLIPINF information directory is composed of a plurality of clip-info files (01000.clpi and 02000.clpi) connected to the above-mentioned stream files on a one-to-one basis. Particularly, the clip-info files (*.clpi) record attribute information and timing information of the stream files (*.m2ts) therein. The clip-info files (*.clpi) connected to the stream files (*.m2ts) on a one-to-one basis are generically named a “Clip”. In other words, this means that a single clip is indicative of data composed of a stream file (*.m2ts) and a clip-info file (*.clpi).

The PLAYLIST directory includes a plurality of playlist files (*.mpls). Each PlayList file (*.mpls) includes one or more PlayItems and one or more SubPlayItems. Each PlayItem and each SubPlayItem are adapted to designate a playing interval during which a specific clip is reproduced. The PlayItem (PI) and the SubPlayItem (SPI) include information associated with a specific clip to be reproduced, i.e., information associated with a reproduction start time (IN-Time) and other information associated with a reproduction termination time (OUT-Time) of the specific clip.

In association with the above-mentioned description, a process for reproducing data using at least one PlayItem (PI) in the PlayList file is referred to as a main path, and a process for reproducing data using individual SubPlayItems (SPIs) is referred to as a sub-path. The PlayList file must contain a single main path. The PlayList file may contain at least one sub-path according to the presence or absence of the SubPlayItem (SPI) as necessary.

In conclusion, the PlayList file acts as a basic reproduction/management file unit contained in overall reproduction/management file structures for reproducing a desired clip by combination of one or more PlayItems.

The BACKUP directory stores a plurality of duplicate files, i.e., a duplicate file (also called “copied files”) of the index file “index” storing information associated with disc reproduction, a duplicate file of the Object file “MovieObject”, a duplicate file of a “Unit Key File”, duplicate files of all PlayList files (*.mpls) contained in the PLAYLIST directory, and duplicate files of all clip information files (*.clpi) contained in the CLIPINF directory. If the above-mentioned files (“index”, “MovieObject”, “Unit Key File”, “*.mpls”, and “*.clpi”) are damaged, a disc reproduction process is also fatally damaged, such that the BACKUP directory is designed to pre-store duplicate files of the above-mentioned files as backup files.

The AACS directory stores information required to protect data stored in a recording medium and/or other data associated with the recording medium simultaneously being downloaded in a local storage. For example, the AACS directory includes a key file including a key capable of decoding encrypted data, a certificate file associated with data of the recording medium and/or data of the local storage, and a usage file corresponding to a data encryption unit, etc.

In association with the above-mentioned description, the file structure according to the present invention is not limited to the above-mentioned titles and locations, and is applicable to other examples as necessary. In other words, the above-mentioned directories and files are not limited to the above-mentioned titles and locations, and should be understood on the basis of their meanings.

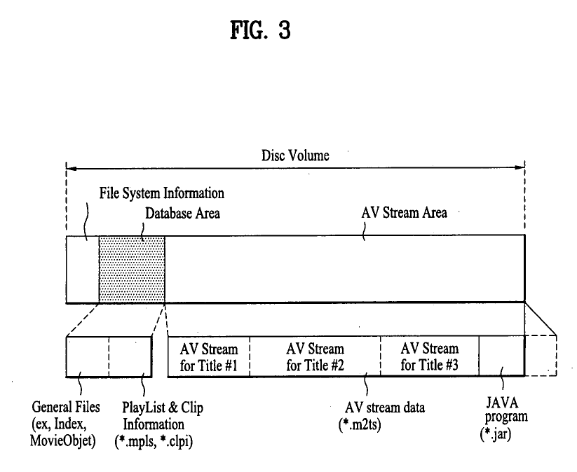

FIG. 3 is a structural diagram illustrating a data record structure recorded in a recording medium according to the present invention. In more detail, FIG. 3 shows a disc record format of information associated with the file structure.

As shown in FIG. 3, from the viewpoint of an inner area of the disc, the above-mentioned disc structure sequentially includes a file system information area serving as system information for managing overall files; a database area for recording an index file, an Object file, a PlayList file, a clip information file, and a metadata file to reproduce a recorded AV stream (*.m2ts); and an AV stream area for recording a plurality of streams composed of audio data, video data, and graphic data, or a JAR file.

A specific area for recording file information to reproduce content data contained in the stream area is referred to as a management area. The file system information area and the database area correspond to the management area. Individual areas shown in FIG. 3 are disclosed for illustrative purposes, and it should be noted that the present invention is not limited to the arrangement structure shown in FIG. 3, and is applicable to other examples as necessary.

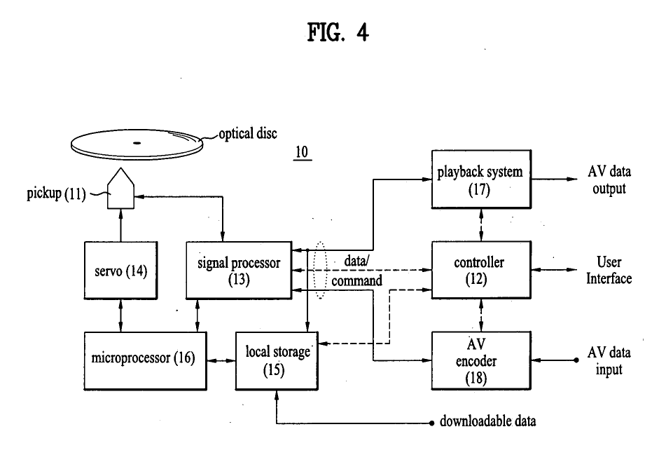

FIG. 4 is a block diagram illustrating the optical recording/reproducing device 10 according to the present invention.

Referring to FIG. 4, the optical recording/reproducing device 10 includes a pickup 11, a servo unit 14, a signal processor 13, and a microprocessor 16. The pickup 11 reproduces original data recorded in the optical disc and management information including reproduction/management file information. The servo 14 controls operations of the pickup 11. The signal processor 13 receives a reproduction signal from the pickup 11, restores the received reproduction signal to a desired signal value, or modulates a signal to be recorded into another signal recorded in the optical disc, such that it transmits the restored or modulated result. The microprocessor 16 controls overall operations of the above-mentioned components.

A controller 12 downloads additional data from outside of the optical disc upon receiving a command from a user, stores the downloaded additional data in the local storage 15, and controls playback system (17) to reproduce the original data stored in the optical disc and/or the additional data stored in the local storage 15 upon receiving a request from a user.

The playback system 17 finally decodes output data (i.e., original data and/or additional data) upon receiving a control signal from the controller 12, and provides the user with the decoded result. The playback system 17 includes a decoder for decoding the AV signal; an object command or application in association with reproduction of the above-mentioned specific title; and a player model for analyzing a user command received from the controller 12, and determining a reproduction direction on the basis of the analyzed result.

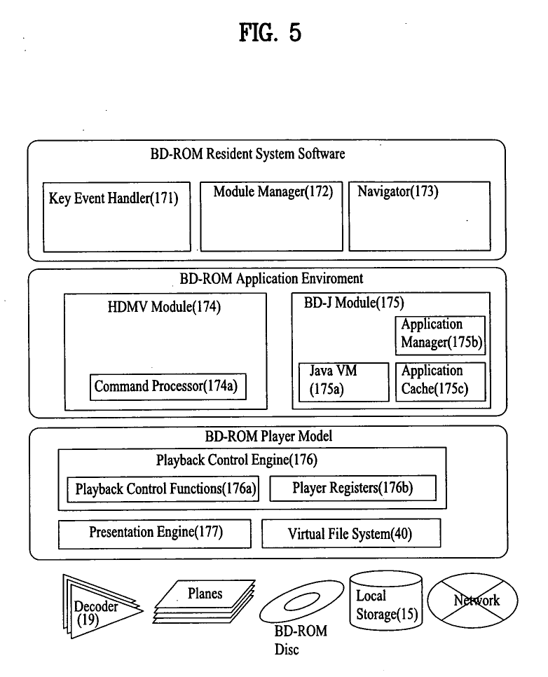

In association with the above-mentioned description, the controller 12 confirms region value of recording/reproducing device, and determines whether output resolution of the data is constrained at a corresponding region. The region value indicates a region where the recording/reproducing device is to be or being played. If the output resolution of the data is constrained at the corresponding region, the controller 12 controlls the playback system 17 to output data in the form of a compressed image. In other words, the content is output in the form of constrained image (for example, in the form of Standard Definition analog output) although the content is HD (High Definition) analog form. Upon receiving a control signal from the controller 12, the playback system 17 outputs the data decoding result in the form of constrained image, or outputs content data in the original resolution. As a result, the controller 12 prevents a fraudulent user from viewing high-definition content data of HD content, resulting in the implementation of content security. In addition, the controller 12 prevents high-definition content data from being duplicated and distributed. A detailed description of the playback system 17 will hereinafter be described with reference to FIG. 5.

The AV encoder 18 converts an input signal into a specific format signal (e.g., an MPEG2 transport stream) upon receiving a control signal from the controller 12, and transmits the converted result to the signal processor 13.

FIG. 5 is a block diagram illustrating an apparatus for reproducing data in a recording medium using the playback system 17 according to the present invention.

In association with the above-mentioned description, the term “playback system” is indicative of a collective reproduction processor implemented by software and/or hardware contained in the optical recording/reproducing device. The playback system is indicative of a system which reproduces data of a recording medium loaded in the optical recording/reproducing device, and at the same time reproduces/manages data (e.g., data downloaded from an external part) stored in the local storage in association with the recording medium.

Specifically, the playback system 17 includes a key event handler 171, a module manager 172, an HDMV module 174, a BD-J module 175, a playback control engine 176, a presentation engine 177, and a virtual file system 40. A detailed description thereof will hereinafter be described.

The HDMV module 174 acting as an additional reproduction process module capable of reproducing the HDMV title and the BD-J module 175 acting as an additional reproduction process module capable of reproducing the BD-J title are constructed independently of each other. The HDMV module 174 receives a command or program contained in the above-mentioned object “Movie Object”, and the BD-J module 175 receives a command or program contained in the above-mentioned object “BD-J Object”, such that the HDMV module 174 and the BD-J module 175 process the received command or program.

The navigator 173 can freely select a desired title upon receiving a control signal from a user, and can provide the user with data of the recording medium and title metadata. The HDMV module 174 and the BD-J module 175 separate a command or application from a hardware structure of the playback system, such that it provides the command or application with portability.

The HDMV module 174 includes a command processor 174a, and the BD-J module 175 includes a JAVA VM 175a, an application manager 175b, and an application cache 175c, such that the HDMV module 174 and the BD-J module 175 can receive/process the above-mentioned command or application.

The JAVA VM 175a is indicative of a virtual machine for executing the application. The application manager 175b includes an application management function for managing a lifecycle of the application. The application manager 175b can load applications from the application cache 175c. In other words, the application cache 175c is indicative of a preload buffer for the BD-J. However, the application may use non-preloaded additional data in the same manner as in a method for loading data from the JAR file. The application cache 175c guarantees a seamless playback of AV data from the recording medium during a loading time of the application, and reduces a time delay encountered by the data loading.

The module manager 172 transmits a user command to the HDMV module 174 and the BD-J module 175, and controls operations of the HDMV module 174 and the BD-J module 175. The playback control engine 176 analyzes PlayList file content data recorded in a disc upon receiving a reproduction command from the HDMV module 174 and the BD-J module 175, and performs a reproduction function on the basis of the analyzed result. The presentation engine 177 decodes/displays a specific a specific stream reproduced/managed by the playback control engine 176.

Specifically, the playback control engine 176 is classified into a playback control function 176a for managing all the reproduction operations, and a player register 176b for storing player status register (PSR) information and general purpose register (GPR) information. The playback control function 176a may also be indicative of the playback control engine 176 as necessary.

The module manager 172, the HDMV module 174, the BD-J module 175, and the playback control engine 176 contained in the playback system can be processed by software. It is preferable that the above-mentioned components 172, 174, 175, and 176 are processed by software instead of hardware. The presentation engine 177, the decoder, and planes are generally hardware based. Constituent components (e.g., 172, 174, 175, and 176) processed by software may be integrated in one unit, such that the integrated unit may be installed into the controller 12. Therefore, it should be noted that the above-mentioned components of the present invention be understood on the basis of their meanings, and are not limited to their implementation methods such as hardware or software implementation.

In recent times, with the increasing development of both a playback apparatus for reproducing/duplicating content data and the Internet, the problem of illegal-duplication and distribution of content data occurs. Particularly, high-definition content data is in danger from hacking, such that the necessity of protecting the high-definition content data has increased. Therefore, a variety of methods for protecting content data have been recently proposed. The present invention controls a fraudulent player having a legal right associated with reproduction of content data to compress/output the content data, such that it can protect the content data from being illegally duplicated or distributed. In more detail, the present invention is characterized in that it assigns specific information for limiting data output resolution according to individual regions to a management file of reproduced data.

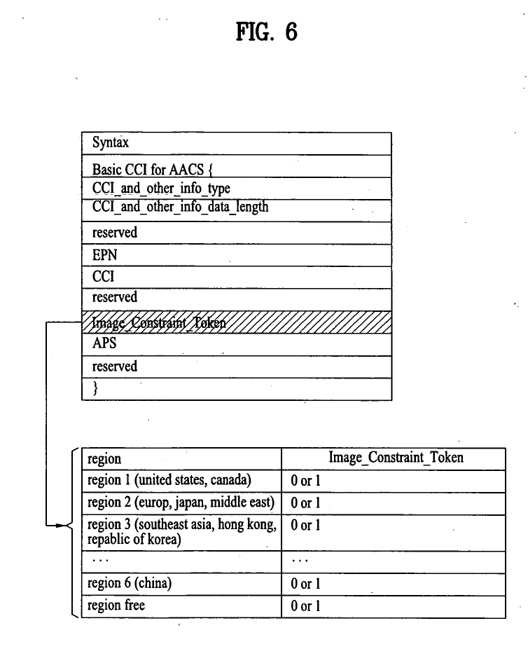

Image Constraint Token (ICT) will hereinafter be described as an example. FIGS. 6 to 8 show examples, each of which includes the ICT in “CPS Unit Usage File”.

In association with the above-mentioned description, the term “CPS (Content Protection System) Unit” is indicative of a group of “First Playback”, “Top Menu”, and/or “Title”. In this case, the “First Playback”, the “Top Menu”, and the “Title” are encrypted using the same key. For example, all AV stream files reproduced by the “First Playback” are contained in the same “CPS Unit” using the same key. All AV stream files reproduced by the “Top Menu” are encrypted by the same key, and are contained in the same “CPS Unit”. In this way, all AV stream files reproduced by a single “Title” are encrypted by the same key, and correspond to the same “CPS Unit”. The “CPS Unit Usage File” may be contained in the AACS directory.

FIG. 6 is a conceptual diagram illustrating information constraining output resolution of data according to a first preferred embodiment of the present invention.

Referring to the data structure shown in FIG. 6, the “Basic CCI for AACS” field is used to explain basic CCI information. The “Basic CCI for AACS” field may include the “CCI_and_other_infor_type” field indicative of CCI type information; the “CCI_and_other_infor_data_length” field indicative of the size of the “CCI_and_other_infor_data” field indicating information associated with the “CPS Unit”; the EPN field indicative of “Encryption Plus Non-assertion (EPN)” information; the CCI field indicative of copy control information; and the APS field indicative of analog copy protection information.

According to the first preferred embodiment of the present invention, ICT information indicating whether content data is outputted at original resolution or is compressed and outputted at low resolution is contained in the “Basic CCI for AACS” field during a data output time. Specifically, the present invention establishes the ICT information according to a region.

FIG. 6 shows an exemplary ICT established according to a region. The present invention is characterized in that the ICT information is assigned to each of all regions where data is to be reproduced. In other words, content provider sets ICT value for each of the regions using ICT field of the “Basic CCI for AACS” field. Referring to FIG. 46, different region codes are assigned to the regions each, and the ICT information is assigned to each region code. For example, a first region code denoted by “region 1” is assigned to the United States and Canada, a second region code denoted by “region 2” is assigned to Europe, Japan, and the Middle East, a third region code denoted by “region 3” is assigned to the Southeast Asia, Hong kong, and the Republic of Korea, and a sixth region code denoted by “region 6” is assigned to China. In this way, unique region codes are assigned to individual countries. Instead of region codes, language code, country code and the like may be used to specify the regions.

Therefore, if the content provider (CP) does not desire to output content data at original resolution within a specific region, the CP determines the ICT value to be “0”. Otherwise, if the CP desires to output the content data at the original resolution within the specific region, the CP determines the ICT value to be “1”. As a result, the CP can allow a user to view CP's content at original image resolution within only the specific region, resulting in a guarantee of content data security. In addition, the CP can protect high-definition content data from hacking.

In association with the above-mentioned description, the CP may desire to establish the ICT information regardless of the region (i.e., region-free ICT information). Needless to say, a unique region code indicative of all regions is assigned to region-free, such that the resultant ICT value irrelevant to the region information can be established. A method for indicating divided regions may be applied to not only a region code but also language code and country code, etc.

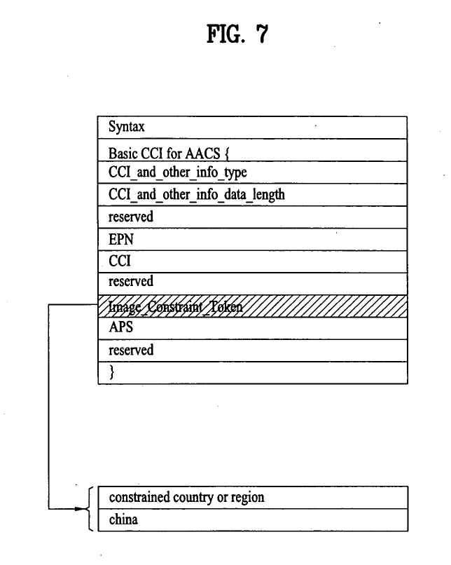

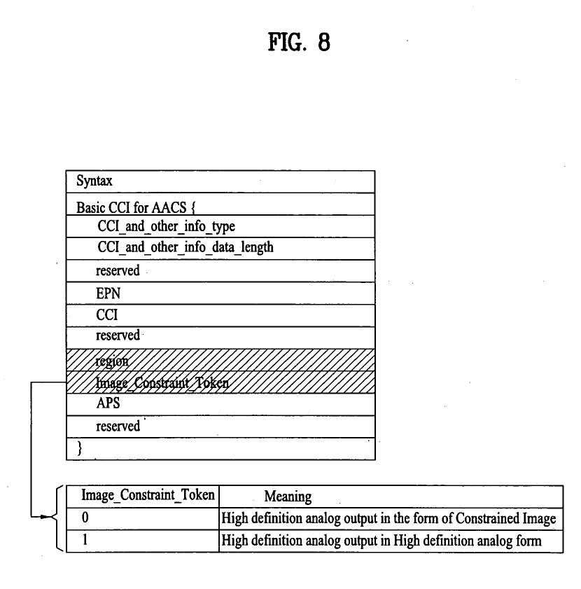

According to the above-mentioned preferred embodiment of the present invention, if content data is outputted in the form of compressed data, the ICT value can be set to “0”. If content data is outputted at original resolution without any change, the ICT value can be set to “1”. However, the present invention is not limited to the above-mentioned examples, and is applicable to other examples as necessary in the same manner as in FIGS. 7 and 8.

FIG. 7 is a conceptual diagram illustrating information constraining output resolution of data according to a second preferred embodiment of the present invention.

In the same manner as in FIG. 6, specific information constraining output resolution of data is contained in the “Basic CCI for AACS” field, and the above-mentioned information is established according to a region. It should be noted that a region in which output resolution of data is constrained is set to the above-mentioned specific information, differently from FIG. 6. Namely, in a region indicated at ICT block, the output resolution is constrained.

Referring to FIG. 7, the content provider (CP) may desire to limit output resolution of data in a specific region (e.g., China or South Korea . . . ). In order to constrain output resolution of data in the specific region, the content provider (CP) may assign specific information indicating the specific region to the ICT field according to the present invention. In this case, if a region indicated by region value of a player for reproducing the content is equal to the specific region indicated by the ICT, the content data is compressed, such that the compressed content data is outputted. In other words, although content data has high-definition resolution, the content data is compressed such that the compressed content data is provided to the user at standard-definition resolution.

In association with the above-mentioned description, a country code or language/region codes and the like of a corresponding country may be used to indicate nation or region in which output resolution of data is constrained.

According to the above-mentioned preferred embodiment of the present invention, although information indicating a constrained country or region is contained in the ICT (Image_Constraint_Token) field, it should be noted that other information indicative of another country or region at which an original image is displayed without any change may also be contained in the ICT field. Furthermore, information indicative of a plurality of countries or regions may also be contained in the ICT field as necessary.

FIG. 8 is a conceptual diagram illustrating information constraining output resolution of data according to a third preferred embodiment of the present invention.

According to the above-mentioned preferred embodiment of the present invention, regional information associated with content data may be contained in the database area. A regional code or a national code, and a language code may be used as the above-mentioned regional information.

Referring to FIG. 8, the “region” field and ICT field each are assigned to the “Basic CCI for AACS” field. The value of the “region” field is indicative of a specific region in which data received from the CP is to be used. In present invention, the value of the “region” field can be adapted to properly establish the ICT value according to a region. For example, in case that the content provider (CP) sets regional information in the “region” field, and sets the ICT value to “0”, content data is outputted in the form of a compressed image in a corresponding region. Otherwise, if the ICT value is set to “1”, content data is outputted at original resolution in a corresponding region. As a result, the ICT value is set to “0” at a high-risk region having a high possibility of generating illegal duplication or hacking of data, resulting in a guarantee of content data security.

In association with the above-mentioned description, although the regional information shown in FIG. 8 is contained in the “Basic CCI for AACS” field, it should be noted that the regional information may also be recorded in management files (e.g., an index file and a playlist file) or a stream header, etc. According to the above-mentioned preferred embodiment of the present invention, although the “region” field is used as an example for better understanding of the present invention, it should be noted that the scope of the present invention may include all fields indicative of region in which content data is to be reproduced irrespective of their names.

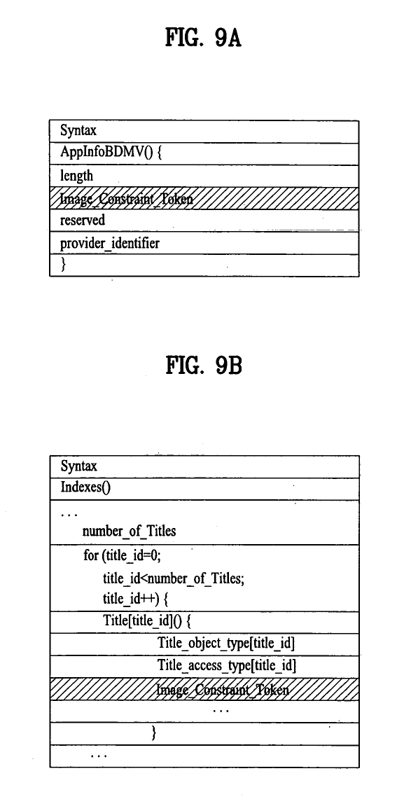

In FIGS. 6 to 8, the information constraining output resolution of data is recorded in the “Basic CCI for AACS” field contained in the “CPS Usage” file, but it should be noted that the information may also be recorded in other management files. A detailed description thereof will hereinafter be described with reference to FIGS. 9A˜9B.

FIGS. 9A˜9B show exemplary record locations at which the information constraining output resolution of data is recorded according to the present invention.

FIG. 9A shows an example in which the information is recorded in the “AppInfoBDMV( )” field contained in the index file. FIG. 9B shows an example in which the information is recorded in the “Title[title_id]” block of the “Indexes( )” field contained in the index file.

Referring to FIG. 9A, general upper-level parameters for disc application are stored in the “AppInfoBDMV( )” field. For example, the “AppInfoBDMV( )” field may include the “Provider_identifier” field indicative of the presence of a content provider. According to the above-mentioned preferred embodiment of the present invention, the information constraining output resolution of data may be recorded in the “AppInfoBDMV( )” field.

In FIG. 9B, the “Title[title_id]” block of the “Indexes( ) ” field includes a plurality of fields for titles designated by the title_ID information. For example, the “Title[title_id]“ block includes the “Title_object_type[title_id]” field indicating object types (i.e., Movie Object and BD-J object, etc.) associated with the titles, and the “Title_access_type[title_id]” field indicating whether the titles can be reproduced by the #∂Title_Search(UO)” information, etc. The “title_id” information begins at the value of “0”, and increases one by one until the number of title IDs is equal to the number of titles (number_of_titles).

If the ICT value is set to the Title-associated block according to the present invention, the content provider (CP) can determine whether to compress an output image for each title or to output an original image by referring to the ICT value.

In association with the above-mentioned description, the ICT value may also be recorded in a stream instead of the management file. In this case, the ICT value may be recorded in a header area of the stream.

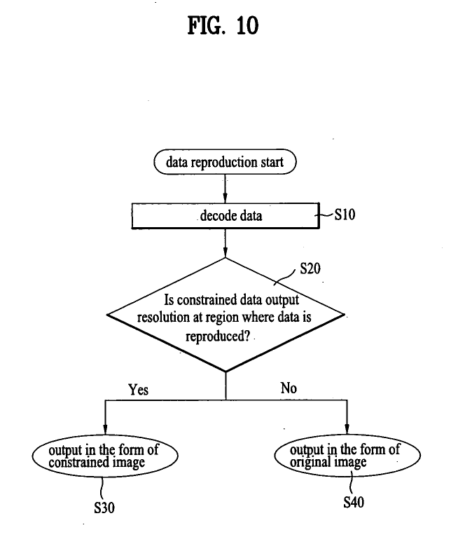

FIG. 10 is a flow chart illustrating a method for reproducing data according to the present invention.

Referring to FIG. 10, if a user enters a data reproduction command, the optical recording/reproducing device reads data from the recording medium and/or the local storage, and provides the playback system 17 with the read data. The data is decoded by a decoder at step S10. The decoded data is transmitted to the user via a display 20. According to the present invention, if the decoded data is outputted in the form of analog data, data is compressed according to ICT values of individual regions or is outputted in the form of original resolution without any change. The player can determine whether output resolution of data is constrained by referring to the ICT value recorded in either the management file or the stream file of the read data of the recording medium and/or the local storage. The Player Registers 176b may indicate a currently-used region of the player or other regions to be used. Therefore, the controller 12 compares current region of the player for reproducing data with ICT information at step S20. Wherein the region value indicates a region where the player is to be played. In case that the output resolution of the above-mentioned region is limited, data is outputted in the form of a constrained image, such that the constrained image is presented to the user at step S30. Otherwise, if the output resolution is not constrained, the playback system outputs the decoded data in the form of original data resolution at step S40.

In the case where the region value of the player is set to a specific country “Republic of Korea” and high-definition content data is provided, associated operations will hereinafter be described with reference to FIG. 6.

The “Republic of Korea” belongs to “region 3”, such that the value indicating the “region 3” may be stored in a Player Status Register of the Player Registers 176b. The above-mentioned value may correspond to a region code, a country code, and a language code, etc. If the ICT value associated with data reproduced by the player is set to “0”, data is outputted in the form of a constrained image. In other words, although data is composed of high-definition content data, the controller 12 controls the playback system to provide user with high-definition analog output in the form of constrained image (i.e., compressed image). As a result, the user is able to view the content at standard-definition resolution. If the ICT value is set to “1”, data is provided user with high-definition analog output in high-definition analog form.

The present invention can protect content data using ICT according to a region until a current time reaches an analog output sunset time. In more detail, although a fraudulent user passes security systems (e.g., a data authentication system, and an encrypted data decoding system, etc.), the playback system according to the present invention prevents content data from being displayed at original resolution using the ICT according to a region. Also, the present invention determines different ICT values according to each region, such that it can process a high-risk region having a high possibility of generating illegal duplication or hacking of data, and a low-risk region having a low possibility of generating the same in different ways. As a result, the content provider (CP) can safely provide content data for the user with a sense of high security, and the user who is located in the high-security region can view the content data at original resolution configured by the content provider (CP).

An apparatus for reproducing data according to the present invention will hereinafter be described with reference to FIGS. 4˜5.

Referring to FIGS. 4˜5, the apparatus for reproducing data includes a playback system 17 for decoding data, and outputting the decoded data; and a controller 12 for controlling the playback system 17.

The controller 12 determines whether output resolution of the data is constrained at a corresponding region in which the data is reproduced by referring to information constraining output resolution of data according to a region, such that it controls the output resolution of the data. If the information indicates that output resolution of a corresponding region is constrained, data is outputted in the form of a constrained image. Otherwise, if the information indicates that the output resolution of the corresponding region is not constrained, original image data is outputted. In brief, a method for outputting high-definition data is differently established according to the information of present invention.

In association with the above-mentioned description, the region value indicating a region where the player can be played may be stored in a memory unit for storing player state information. For example, a Player Status Register of the Player Registers 176b may act as the memory unit.

As apparent from the above description, a recording medium, and a method and apparatus for reproducing data from the recording medium according to the present invention can allow a content provider (CP) to provide a user with safe content data, and can allow the CP to differently determine a content protection degree according to individual regions, thereby protecting the content provider (CP) and a legitimate user authorized by the content provider (CP).

In addition, the recording medium, and the method and apparatus for reproducing data from the recording medium according to the present invention can prevent content data from being illegally duplicated or distributed by a fraudulent user, and can assign different content protection degrees to individual regions, resulting in the creation of more convenient functions for the content provider (CP) and the legitimate user.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. A recording medium comprising:
a first-type area for storing content data; and
a second-type area for storing information constraining output resolution of the data according to a region.

2. The recording medium according to claim 1, wherein the second-type area is a database area.

3. The recording medium according to claim 1, wherein the second-type area is a header area of a stream.

4. The recording medium according to claim 1, wherein the information is Image Constraint Token (ICT).

5. The recording medium according to claim 1, wherein the information indicates whether to constrain output resolution of the data in each of regions.

6. The recording medium according to claim 1, wherein the information specifies a region in which output resolution of the data is constrained.

7. The recording medium according to claim 1, wherein the second-type region includes:
a first area for storing information of a region in which the content data is to be reproduced; and
a second area for storing information indicating whether to constrain output resolution of the data.

8. The recording medium according to claim 1, wherein the information is stored according to each title.

9. The recording medium according to claim 1, wherein the region is indicated by a region code.

10. The recording medium according to claim 1, wherein the region is indicated by a country code.

11. The recording medium according to claim 1, wherein the region is indicated by a language code.

12. A method for reproducing data comprising the steps of:
a) confirming information constraining output resolution of the data according to a region;
b) comparing the information with region value indicating a region in which a player is to be played; and
c) outputting the data according to the result of the comparison.

13. The method according to claim 12, wherein the data is output in the form of constrained image in case that the result indicates that the output resolution is constrained in the corresponding region.

14. The method according to claim 12, wherein the data is output in the form of original image in case that the result indicates that the output resolution is not constrained in the corresponding region.

15. The method according to claim 12, wherein the region value is stored in a “Player Status Register”.

16. The method according to claim 12, wherein the information indicates whether to constrain output resolution of the data in each of regions.

17. The method according to claim 12, wherein the information specifies a region in which the output resolution of the data is constrained.

18. The method according to claim 12, wherein the information is confirmed by referring to both a first area for storing information of a region in which the data is to be reproduced and a second area for storing indicating whether output resolution of the data is constrained.

19. An apparatus for reproducing data comprising:
a playback system storing region value of the apparatus; and
a controller confirming information constraining output resolution of the data, the controller comparing the information with region value indicating a region in which the apparatus is to be played, the controller controlling the playback system to output the data according to the result of the comparison.

20. The apparatus according to claim 19, wherein the controller outputs the data in the form of constrained image in case that the result indicates that the output resolution is constrained in the corresponding region.

21. The apparatus according to claim 19, wherein the controller outputs the data in the form of original image in case that the result indicates that the output resolution is not constrained in the corresponding region.

22. The apparatus according to claim 19, wherein the region value is stored in a “Player Status Register” of the playback system.
